(19) United States
(12) Patent Application Publication
(10) Pub. No.: US 2023/0081777 A1
(43) Pub. Date: Mar. 16, 2023

(54) Production device, in particular SMC production device, for a production of thermoset semifinished products

(71) Applicant: Schmidt & Heinzmann GmbH & Co., KG, Bruchsal (DE)

(72) Inventor: David Bücheler, Weingarten (DE)

(21) Appl. No.: 17/942,395

(22) Filed: Sep. 12, 2022

(30) Foreign Application Priority Data
Sep. 10, 2021 (DE) 10 2021 123 510.3

(51) Int. Cl. B29C 70/18; B29C 70/54; B29C 70/50

(52) U.S. Cl. CPC B29C 70/18; B29C 70/546; B29C 70/541; B29C 70/504; B29C 2037/90

(57) ABSTRACT

A production device for a production of thermoset semifinished products comprises at least one material application unit (12) for applying a material (14) to a carrier element (16), wherein the production device further comprises at least one recording unit (18), which has at least one sensor element (20), for recording a thickness (22) of the material (14) applied to the carrier element (16).

### CROSS REFERENCE TO RELATED APPLICATIONS

This application is based on and incorporates herein by reference the German patent application DE 10 2021 123 510.3 filed on Sep 10, 2021.

### PRIOR ART

The invention relates to a production device, in particular an SMC production device, for a production of semifinished products.

A production device, in particular an SMC production device, for a production of thermoset semifinished products, with at least one material application unit, in particular a doctor blade unit, for applying a material, in particular a resin matrix, to a carrier element, in particular a carrier film, has already been proposed.

The object of the invention is in particular to provide a production device of the generic type that has a high quality of production. The object is achieved according to the invention, while advantageous configurations and developments of the invention can be taken from the subclaims.

### ADVANTAGES OF THE INVENTION

The invention is based on a production device, in particular on an SMC production device, for a production of thermoset semifinished products, such as for example sheet molding compounds (SMCs), prepregs or the like, with at least one material application unit, in particular a doctor blade unit, for applying a material, in particular a resin matrix, to a carrier element, in particular a carrier film.

It is proposed that the production device comprises at least one recording unit, which has at least one sensor element, in particular an optical sensor element, for recording a thickness, in particular maximum thickness, of the material applied to the carrier element. The recording unit is preferably configured to contactlessly record a thickness, in particular maximum thickness, of the material applied to the carrier element. The recording unit is preferably configured to optically record a thickness, in particular maximum thickness, of the material applied to the carrier element. The sensor element is preferably formed as an optical sensor element, such as for example as a light sensor, in particular a laser sensor or a confocal-chromatic sensor or the like. It is however also conceivable that the recording unit is configured to acoustically or haptically record a thickness, in particular maximum thickness, of the material applied to the carrier element. “Configured” is to be understood as meaning in particular specifically designed and/or specifically equipped. That an element and/or a unit is configured for a specific function is to be understood as meaning in particular that the element and/or the unit satisfy/satisfies and/or perform/performs this specific function in at least one application state and/or operating state.

The sensor element is preferably arranged in a vicinity of an application opening of the material application unit. A “vicinity of the application opening” is to be understood as meaning a region around the application opening that is at a maximum distance from the application opening which is in particular less than 1 m, preferably less than 0.5 m and particularly preferably less than 0.25 m. A size, in particular a height, of the application opening can preferably be set by means of a closing and/or stripping element, in particular a doctor blade element, of the material application unit, in particular as a result of a movement of the closing and/or stripping element in relation to a material receiving element, in particular a doctor box, of the material application unit. A thickness, in particular maximum thickness, of the material applied to the carrier element can preferably be predetermined by a size, in particular a height, of the application opening. By means of the recording unit, a thickness, in particular maximum thickness, of the material applied to the carrier element, which can be applied to the carrier element through the application opening, can be checked. If there is a deviation from the desired thickness, in particular maximum thickness, of the material applied to the carrier element, a readjustment, in particular an automatic and/or manual readjustment, of the thickness, in particular maximum thickness, of the material applied to the carrier element can advantageously take place as a result of changing a position of the closing and/or stripping element, in particular the doctor blade element, of the material application unit in relation to the material receiving element, in particular the doctor box.

An “SMC production device” is to be understood as meaning in particular a device which forms at least part of a production installation for the production of fiber-reinforced thermoset materials, sheet molding compounds (SMCs). The production installation, in particular an SMC production installation, is preferably configured for production of mat-like molding compounds, in particular resin mats. The production installation, in particular the SMC production installation, is preferably connected by conveying devices, such as for example conveyor belts, industrial robots etc., to a further-processing production device, such as for example a press etc. For transporting the carrier element and/or the applied material, the production device preferably has a transporting unit, which may be part of a conveying and/or transporting unit of the production installation or may be formed separately from it. A “transporting unit” is to be understood as meaning in particular a unit for transporting at least one production item, in particular the material, along a predetermined production direction. The transporting unit preferably comprises at least one conveyor belt and/or at least one conveyor roller. Particularly preferably, the transporting unit comprises at least one conveyor belt and at least one rolling element, on which the conveyor belt at least temporarily rests and/or which is at least partially wrapped around by the conveyor belt. It is however also conceivable that the transporting unit alternatively or additionally has other transporting elements that appear appropriate to a person skilled in the art, such as for example air-cushion conveyors or the like. The carrier element may be formed as a carrier film, which can be conveyed by means of the transporting unit, or the carrier element may be formed as part of the transporting unit, in particular as a conveyor belt. In the case of a configuration of the carrier element as part of the transporting unit, in particular as a conveyor belt, the carrier element preferably has a coating which allows the applied material to be detached from the carrier element. The coating may for example protect the carrier element formed as a conveyor belt from contaminants and/or from adhesive attachment of the material. It is however also conceivable that the carrier element is formed as carrier powder, which may be applied to a conveyor belt of the transporting unit, in particular in order to protect the conveyor belt from contaminants and/or from adhesive attachment of the material. In a preferred configuration, the carrier element is formed as a carrier film to which the material, in particular the resin matrix, has been applied. In particular, the carrier film together with the material applied to it can be transported by means of the transporting unit, in particular to further processing stations of the production device, such as for example to a fiber-cutting unit, by means of which fibers that can be fed to the material applied to the carrier film or the like can be cut.

By means of the configuration according to the invention, a high quality of the process can be advantageously achieved. A thickness, in particular maximum thickness, of the material applied to the carrier element, which can be applied to the carrier element through the application opening, can advantageously be checked by means of the recording unit. A structurally simple configuration of the recording unit for checking a thickness, in particular maximum thickness, of the material applied to the carrier element can be advantageously achieved.

Furthermore, in particular in a preferred configuration of the production device according to the invention, it is proposed that the sensor element is formed as a confocal-chromatic sensor. The sensor element is preferably formed in such a way that white light is split into different spectra by way of lenses of the sensor element and is focused onto an object, in particular the applied material, by a multi-lens optical unit of the sensor element. The lenses are arranged in such a way that the light is split into distance-dependent monochromatic wavelengths by controlled chromatic aberration. In a sensor controller of the sensor element, the wavelength that focuses exactly on the object, in particular the applied material, is used for the measurement. This advantageously allows a high resolution and a small point of light to be achieved by means of the sensor element. The sensor element is preferably configured to emit light with a wavelength of in particular less than 800 nm, preferably less than 700 nm and most particularly preferably with a wavelength from a wavelength range of 490 nm to 650 nm. By means of the configuration according to the invention, a precise recording of the thickness of the applied material can be advantageously achieved—both on diffuse surfaces and on reflective surfaces. A high-resolution measurement into the nanometer range can be advantageously made possible. A high measuring accuracy along with high measuring rates can be advantageously made possible, in particular even in the case of changing surface colors or in the case of a transparent resin matrix. A high quality of the process can be advantageously achieved.

It is also proposed that the recording unit has at least one holding-down element, which is configured to subject the carrier element at least section-wise to a force in the direction of a bearing surface of the material application unit on which the carrier element at least partially rests. The holding-down element is preferably arranged in addition to a pressure-exerting element, in particular a pressure-exerting roller, of the material application unit in the vicinity of the application opening. The holding-down element is preferably arranged on the bearing surface on a side of the carrier element that is facing away from the sensor element. The carrier element can preferably be moved over the holding-down element during operation of the production device, in particular along a direction running at least substantially parallel to the bearing surface, while the holding-down element is subjecting the carrier element to a force in the direction of the bearing surface. “Substantially parallel” is to be understood as meaning in particular an alignment of a direction in relation to a reference direction, in particular in a plane, the direction having a deviation of in particular less than 8°, advantageously less than 5° and particularly advantageously less than 2°, with respect to the reference direction. The holding-down element is preferably configured to subject the carrier element to a force, in particular tensile force, running at least substantially perpendicularly to the bearing surface. The expression “substantially perpendicularly” is to be understood as defining in particular an alignment of a direction in relation to a reference direction, the direction and the reference direction forming an angle of 90°, in particular in a projection plane, and the angle having a maximum deviation of in particular less than 8°, advantageously less than 5° and particularly advantageously less than 2°. The holding-down element, in particular a holding-down surface of the holding-down element, preferably has a maximum longitudinal extent which is a multiple less than a maximum longitudinal extent of the bearing surface. The maximum longitudinal extent of the holding-down element, in particular the holding-down surface of the holding-down element, may be identical to a maximum transverse extent of the holding-down element, in particular the holding-down surface of the holding-down element, in particular in the case of a configuration of the holding-down element with a square or circular holding-down surface, or be different from the maximum transverse extent of the holding-down element, in particular the holding-down surface of the holding-down element. In a state of the holding-down element in which it is arranged on the bearing surface, the maximum longitudinal extent of the holding-down element, in particular the holding-down surface of the holding-down element, preferably runs at least substantially parallel to a transporting direction of the production device, in particular in the region of the material application unit along which the carrier element is moved during operation of the production device. The maximum transverse extent of the holding-down element, in particular the holding-down surface of the holding-down element, preferably runs at least substantially perpendicularly to the transporting direction and/or to the maximum longitudinal extent of the holding-down element, in particular the holding-down surface of the holding-down element. The recording unit may have a single holding-down element or a multiplicity of holding-down elements, which is/are configured to subject the carrier element at least section-wise to a force in the direction of the bearing surface of the material application unit on which the carrier element at least partially rests. By means of the configuration according to the invention, lifting off of the carrier element from the bearing surface, which could influence a measurement result, can be advantageously counteracted. A high repetition accuracy of a measurement can advantageously take place. A low calibration rate of the recording unit can be advantageously made possible. A precise recording of the thickness of the applied material can be advantageously achieved. A high quality of the process can be advantageously achieved.

It is also proposed that the recording unit has at least one holding-down element, in particular the already aforementioned holding-down element, the sensor element and the holding-down element being arranged overlapping, in particular considered along a direction running at least substantially perpendicularly to a bearing surface, in particular the already aforementioned bearing surface, of the material application unit. The holding-down element and the sensor element are preferably arranged relatively at a distance from one another along the direction running at least substantially perpendicularly to the bearing surface of the material application unit. In particular in the case of a projection of a maximum holding-down surface of the holding-down element and a maximum surface of transverse extent of the sensor element along the direction running at least substantially perpendicularly to the bearing surface of the material application unit into a common plane, the maximum holding-down surface of the holding-down element and the maximum surface of transverse extent of the sensor element overlap in particular by more than 30%, preferably by more than 50%, most preferably by more than 70% and particularly preferably by more than 90%. By means of the configuration according to the invention, a precise recording of the thickness of the applied material can be advantageously achieved, in particular since holding down of the carrier material in the region of the sensor element can be advantageously achieved. Lifting off of the carrier element from the bearing surface, which could influence a measurement result, can be advantageously counteracted. A high repetition accuracy of a measurement can advantageously take place. A low calibration rate of the recording unit can be advantageously made possible. A high quality of the process can be advantageously achieved.

It is also proposed that the recording unit has at least one holding-down element, in particular the already aforementioned holding-down element, which is formed as a negative-pressure holding element, in particular as a vacuum gripper or as a flow gripper. The holding-down element may be formed as a flat suction gripper, as a bellows suction gripper, as a flow gripper or as some other vacuum gripper that appears appropriate to a person skilled in the art. The recording unit preferably comprises a connection interface for a connection of the holding-down element to an external negative-pressure device or the recording unit itself comprises a negative-pressure generator, which is connected to the holding-down element by means of a negative-pressure line of the recording unit. It is also conceivable that the holding-down element generates the negative pressure itself, such as for example by the holding-down element, which is supplied with compressed air, controlling or regulating an intensity of the compressed air, in particular of the compressed air flowing out of the holding-down element, in particular in order to vary a magnitude of a holding-down force. The external negative-pressure device or the negative-pressure generator is preferably formed as a vacuum pump. It is however also conceivable that the external negative-pressure device or the negative-pressure generator has some other configuration that appears appropriate to a person skilled in the art. A magnitude of a negative pressure that can be generated at the holding-down element can preferably be set, in particular by means of the external negative-pressure device or by means of the negative-pressure generator, in such a way that lying of the carrier element against the bearing surface in the region of the holding-down element can be realized while at the same time the carrier element is movable along the transporting direction in relation to the bearing surface. It is alternatively or additionally conceivable that there are arranged in the region of the holding-down surface one or more compensating openings of the recording unit, which are configured to set a magnitude of a negative pressure that can be generated on the holding-down element in such a way that lying of the carrier element against the bearing surface in the region of the holding-down element can be realized while at the same time the carrier element is movable along the transporting direction in relation to the bearing surface. By means of the configuration according to the invention, holding down that does not adversely affect the material, in particular a carrier element, can be advantageously achieved. A precise recording of the thickness of the applied material can be advantageously achieved, in particular since holding down of the carrier element in the region of the sensor element can be advantageously achieved. Lifting off of the carrier element from the bearing surface, which could influence a measurement result, can be advantageously counteracted. A high repetition accuracy of a measurement can advantageously take place. A low calibration rate of the recording unit can be advantageously made possible. A high quality of the process can be advantageously achieved.

It is also proposed that the recording unit has at least one holding-down element, in particular the already aforementioned holding-down element, which has a maximum holding-surface extent which is less than a maximum transverse extent of a bearing surface, in particular the already aforementioned bearing surface of the material application unit. It is conceivable that the recording unit has a multiplicity of holding-down elements, which are arranged on the bearing surface such that they are evenly or unevenly distributed over the maximum transverse extent of the bearing surface, that the recording unit has a single holding-down element, which is arranged on the bearing surface symmetrically or unsymmetrically in relation to the maximum transverse extent of the bearing surface, or that the recording unit has all of the aforementioned variants of holding-down elements in terms of configuration and/or arrangement. By means of the configuration according to the invention, a substantially punctiform or linear arrangement of holding-down elements can be advantageously achieved. An existing installation space can be used particularly advantageously. A precise recording of the thickness of the applied material can be advantageously achieved, in particular since holding down of the carrier element in the region of the sensor element can be advantageously achieved. Lifting off of the carrier element from the bearing surface, which could influence a measurement result, can be advantageously counteracted. A high repetition accuracy of a measurement can advantageously take place. A low calibration rate of the recording unit can be advantageously made possible. A high quality of the process can be advantageously achieved.

It is also proposed that the recording unit has at least one holding-down element, in particular the already aforementioned holding-down element, which is arranged on a bearing surface, in particular the already aforementioned bearing surface, of the material application unit within a recording region of the sensor element. The holding-down surface of the holding-down element is preferably arranged on the bearing surface of the material application unit within the recording region of the sensor element. A main emitting direction of the sensor element preferably intersects the holding-down surface of the holding-down element. The main emitting direction of the sensor element preferably runs transversely, in particular at least substantially perpendicularly, to the bearing surface of the material application unit. A precise recording of the thickness of the applied material can be advantageously achieved, in particular since holding down of the carrier element in the region of the sensor element can be advantageously achieved. Lifting off of the carrier element from the bearing surface, which could influence a measurement result, can be advantageously counteracted. A high repetition accuracy of a measurement can advantageously take place. A low calibration rate of the recording unit can be advantageously made possible. A high quality of the process can be advantageously achieved.

It is also proposed that the production device comprises at least one actuator unit, which is configured to set at least one position of a closing and/or stripping element of the material application unit in relation to a bearing surface, in particular the already aforementioned bearing surface of the material application unit and/or in relation to the carrier element in dependence on a thickness of the applied material recorded by means of the sensor element. The actuator unit may be configured to move the closing and/or stripping element translationally or rotationally. The actuator unit is preferably configured to move the closing and/or stripping element translationally along a movement axis of the closing and/or stripping element that runs at least substantially perpendicularly to the bearing surface. The closing and/or stripping element is preferably formed as a doctor blade element. The closing and/or stripping element is preferably configured to open or close an application opening of a doctor box of the material application unit. The production device preferably comprises at least one computing unit, which is configured at least for processing sensor signals of the sensor element and for activating the actuator unit in dependence on the sensor signals. The computing unit is preferably configured for activating the holding-down element. The computing unit may alternatively or additionally be configured for activation of further processes, units and/or elements of the production device. A “computing unit” is to be understood as meaning in particular a unit with an information input, information processing and an information output. The computing unit advantageously has at least one processor, a memory, input and output means, further electrical components, an operating program, regulating routines, control routines and/or calculation routines. The components of the computing unit are preferably arranged on a common printed circuit board and/or advantageously arranged in a common housing. A high degree of automation can be advantageously achieved by means of the configuration according to the invention. A precise setting of a thickness, in particular maximum thickness, of the material applied to the carrier element can be advantageously made possible. A high quality of the process can be advantageously achieved.

The invention is also based on a method for a production of thermoset semifinished products, in particular by using a production device according to the invention. It is proposed that, in at least one method step, a thickness, in particular maximum thickness, of a material, in particular a resin matrix, applied to a carrier element, in particular the already aforementioned carrier element, is recorded by means of a sensor element, in particular an optical sensor element, of a recording unit, in particular the already aforementioned recording unit. Preferably, the material to be applied is produced in at least one method step, in particular as a result of mixing of individual components of the material, such as for example a crosslinkable resin, additives, such as for example additives for reducing shrinkage, release agents, catalysts or the like. After production, in particular after mixing, the material to be applied is preferably fed to the production device, in particular the material application unit. It is however alternatively or additionally conceivable that the material to be applied is fed in an already ready-mixed state to the production device, in particular the material application unit, as a ready-to-use mix from containers, such as for example tanks or the like, or by way of a pipeline system. In particular after mixing, the material to be applied is preferably applied to the carrier element by means of the material application unit. A thickness, in particular maximum thickness, of the material, in particular a resin matrix, applied to the carrier element, is preferably monitored in at least one method step, in particular as a result of an evaluation of the signal data of the sensor element by the computing unit. In at least one method step, fibers, in particular cut fibers, are preferably applied to the carrier element on which the material, in particular the resin matrix, has already been applied. In particular, in at least one method step, the material, in particular the resin matrix, is once again applied to the carrier element on which the material, in particular the resin matrix, and the fibers have already been applied. Preferably, in at least one method step, feeding of the carrier element and of the material applied to it as to a drying unit of the production installation takes place. Alternatively, it is also conceivable that the production installation is formed without the drying unit, feeding of the carrier element and the material applied to it to a storage unit taking place in at least one method step, in order to carry out a maturing process. For example, for the maturing process, the carrier element and the material applied to it are brought into a temperature-controlled space of the storage unit, the carrier element and the material applied to it remaining there for a predetermined time, in particular a few days, to mature. During the maturing, preferably the viscosity of the resin matrix increases, so that during the following further processing the carrier element can be pulled off from the material and the material can therefore also be handled without the carrier element. As already stated above, the maturing process can be realized within a short time period by means of the drying unit of the production installation, in order to make advantageous direct further processing possible, in particular in a configuration of the method as a direct SMC production process. Drying, in particular by means of the drying unit of the production installation, is preferably followed by further processing or storage of the carrier element and the material applied to it. By means of the configuration according to the invention, a high quality of the process can be advantageously achieved. A thickness, in particular maximum thickness, of the material applied to the carrier element, which can be applied to the carrier element through the application opening, can be advantageously checked by means of the recording unit.

It is also proposed that, in at least one method step the carrier element is at least section-wise subjected to a force in the direction of a bearing surface, in particular the already aforementioned bearing surface, of a material application unit, in particular the already aforementioned material application unit, on which the carrier element at least partially rests, by means of a holding-down element, in particular the already aforementioned holding-down element, of a recording unit, in particular the already aforementioned recording unit. At least during recording of a thickness, in particular maximum thickness, of the material, in particular the resin matrix, applied to the carrier element, by means of the sensor element of the recording unit, the carrier element is preferably subjected to a force in the direction of the bearing surface by means of the holding-down element. It is conceivable that the holding-down element only subjects the carrier element to a force in the direction of the bearing surface temporarily or that the holding-down element subjects the carrier element to a force in the direction of the bearing surface, at least in the region of the sensor element, during an entire operating time of the production device. The carrier element is preferably conveyed continuously, application of the material to the carrier element likewise taking place continuously. In particular, recording of a thickness, in particular maximum thickness, of the material, in particular resin matrix, applied to the carrier element by means of the sensor element likewise takes place continuously. It is however also conceivable that alternatively or additionally intermittent conveyance of the carrier element and/or intermittent recording of a thickness, in particular maximum thickness, of the material applied to the carrier element takes place. A high quality of the process can be advantageously achieved by means of the configuration according to the invention. A thickness, in particular maximum thickness, of the material applied to the carrier element, which can be applied to the carrier element through the application opening, can be advantageously checked by means of the recording unit.

The production device according to the invention and/or the method according to the invention are/is not configured here to be restricted to the application and embodiment described above. In particular, the production device according to the invention and/or the method according to the invention may have a number of individual elements, components and units as well as method steps that differs from a number mentioned herein in order to perform a way of functioning described herein. Moreover, in the value ranges specified in this disclosure, values lying within the mentioned limits are also to be considered to be disclosed and arbitrarily usable.

### DRAWINGS

Further advantages will become evident from the following description of the drawings. The drawings illustrate an exemplary embodiment of the invention. The drawings, the description and the claims contain numerous features in combination. A person skilled in the art will also expediently consider the features individually and combine them to form appropriate further combinations.

In the figures:

FIG. 1 shows a production device according to the invention as part of a production installation, in particular an SMC production installation, in a schematic representation,

FIG. 2 shows a basic representation of a way of functioning of a material application unit and a recording unit of the production device according to the invention in a schematic representation,

FIG. 3 shows a sectional view of the material application unit and the recording unit of the production device according to the invention in a schematic representation,

FIG. 4 shows a view of a detail of the recording unit of the production device according to the invention in a schematic representation and

FIG. 5 shows a sequence of a method according to the invention, at least for a production of thermoset semifinished products, in a schematic representation.

### Description of the exemplary embodiment

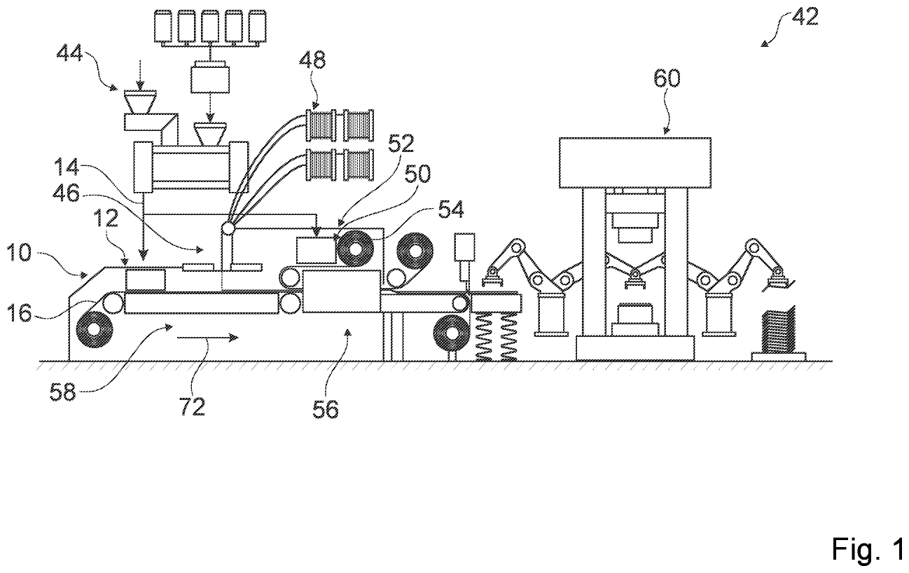

FIG. 1 shows a production installation 42, in particular an SMC production installation, for a production of thermoset semifinished products. The production installation 42 preferably comprises a mixing unit 44 for producing a material 14, in particular a resin matrix, to be applied to a carrier element 16. The mixing unit 44 is preferably configured, in a way already known to a person skilled in the art, for mixing individual components of the material 14 to be applied, such as for example a crosslinkable resin and/or additives, such as for example additives for reducing shrinkage, release agents, catalysts or the like. It is however also conceivable that, as an alternative or in addition to the mixing unit 44, the production installation 42 has a material feeding unit (not represented any more specifically here), which is configured to feed an already ready-mixed material 14 to be applied, for example from an external material tank (not represented any more specifically here) at least to a production device 10, comprising a material application unit 12, of the production installation 42. The mixing unit 44 or the material feeding unit is preferably connected by way of feed lines of the production installation 42 at least to the material application unit 12, in particular in order to feed the material 14 to be applied to the material application unit 12. The material application unit 12 is configured for applying the material 14, in particular the resin matrix, to the carrier element 16, in particular a carrier film. The material application unit 12 is formed in particular as a doctor blade unit.

The production installation 42 preferably comprises at least one fiber-cutting unit 46 and/or a fiber-feeding unit 48, which are/is configured to feed or apply, in particular in a way already known to a person skilled in the art, fibers, in particular cut fibers, to the carrier element 16, to which the material 14, in particular the resin matrix, has already been applied. The production installation 42 preferably has a further production device 52, which at least comprises a further material application unit 50 and is preferably connected to the mixing unit 44 or to the material feeding unit by way of feed lines of the production installation 42, in particular in order likewise to feed material 14 to the further material application unit 50. The further material application unit 50 is preferably configured to feed material 14 to the carrier element 16, in particular once the fibers have been fed, or to feed material 14 to a further carrier element 54 which can be brought together in an overlapping manner, in particular in a way already known to a person skilled in the art, with the carrier element 16 to which material 14 and fibers have already been applied. The production device 10 and the further production device 52 preferably have an analogous configuration.

The production installation 42 preferably comprises a drying unit 56 for drying the applied material 14, in particular in a way already known to a person skilled in the art. The drying unit 56 is in particular operatively connected, in a manner already known to a person skilled in the art, by means of a conveying and/or transporting unit 58 of the production installation 42, in particular in order to realize feeding of the carrier element 16 and/or of the further carrier element 54. In particular, the conveying and/or transporting unit 58 of the production installation 42 is configured to feed the thermoset semifinished products, obtained as a result of drying, to further processing of a further-processing production device 60, such as for example a press etc., or to a storage device (not represented any more specifically here) for storage.

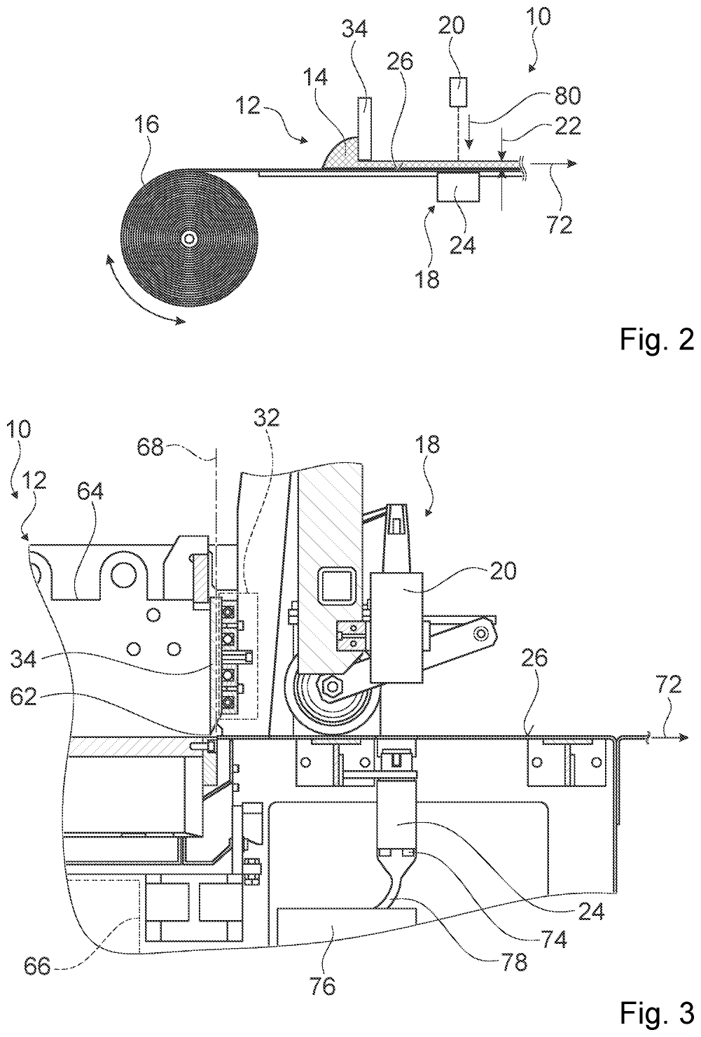

FIG. 2 shows a basic diagram of the production device 10. The following description of the production device 10 preferably also applies to the further production device 52. The production device 10 comprises at least the material application unit 12, in particular the doctor blade unit, for applying the material 14, in particular the resin matrix, to the carrier element 16. The carrier element 16 is formed in particular as a carrier film. It is however also conceivable that the carrier element 16 is formed as a conveyor belt, in particular of the conveying and/or transporting unit 58, and the material application unit 12 applies the material 14 directly to the conveyor belt. The production device 10 comprises at least one recording unit 18, which has at least one sensor element 20, in particular an optical sensor element, for recording a thickness 22, in particular maximum thickness, of the material 14 applied to the carrier element 16. The recording unit 18 is preferably configured to contactlessly record a thickness 22, in particular maximum thickness, of the material 14 applied to the carrier element 16. The recording unit 18 is preferably configured to optically record a thickness 22, in particular maximum thickness, of the material 14 applied to the carrier element 16. The sensor element 20 is preferably formed as an optical sensor element, such as for example as a light sensor, in particular a laser sensor or a confocal-chromatic sensor or the like. The sensor element 20 is preferably formed as a confocal-chromatic sensor.

The sensor element 20 is preferably arranged in a vicinity of an application opening 62 (cf. FIG. 3) of the material application unit 12. A size, in particular a height, of the application opening 62 can preferably be set by means of a closing and/or stripping element 34 (cf. FIG. 3), in particular a doctor blade element, of the material application unit 12, in particular as a result of a movement of the closing and/or stripping element 34 in relation to a material receiving element 64 (cf. FIG. 3), in particular a doctor box, of the material application unit 12. A thickness 22, in particular maximum thickness, of the material 14 applied to the carrier element 16 can preferably be predetermined by a size, in particular a height, of the application opening 62. By means of the recording unit 18, a thickness 22, in particular maximum thickness, of the material 14 applied to the carrier element 16, which can be applied to the carrier element 16 through the application opening 62, can be checked. If there is a deviation from the desired thickness 22, in particular maximum thickness, of the material 14 applied to the carrier element 16, a readjustment, in particular an automatic and/or manual readjustment, of the thickness 22, in particular maximum thickness, of the material 14 applied to the carrier element 16 can advantageously take place as a result of changing a position of the closing and/or stripping element 34, in particular the doctor blade element, of the material application unit 12 in relation to the material receiving element 64, in particular the doctor box. The production device 10 or the production installation 42 comprises at least one computing unit 66. The computing unit 66 is preferably configured at least to evaluate signal data of the sensor element 20.

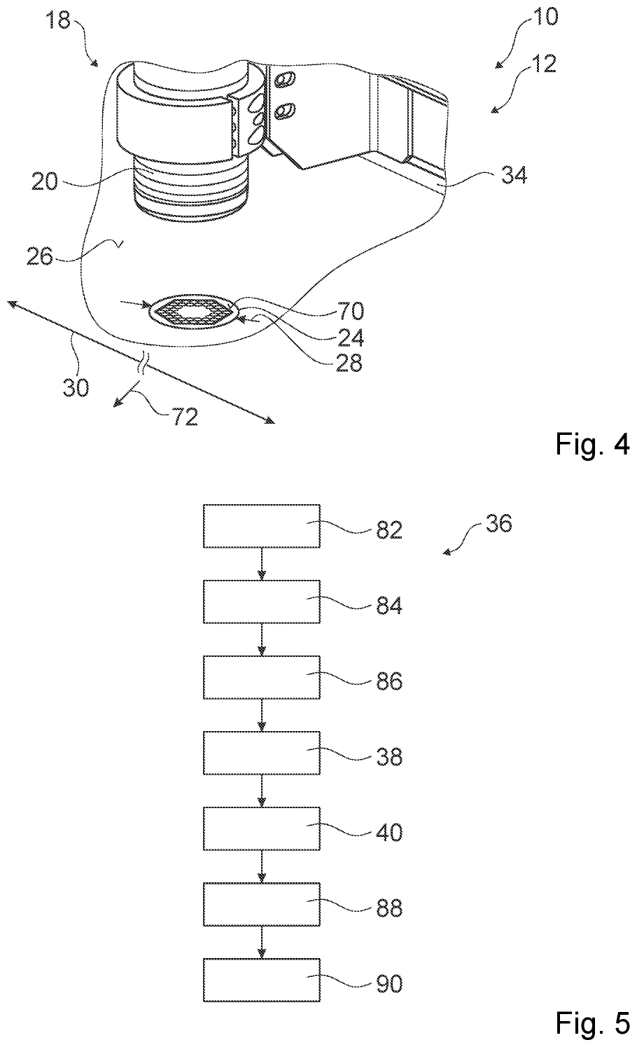

The production device 10 comprises at least one actuator unit 32 (cf. FIG. 3), which is configured to set at least one position of the closing and/or stripping element 34 of the material application unit 12 in relation to a bearing surface 26 (cf. FIGS. 3 and 4) of the material application unit 12 and/or in relation to the carrier element 16 in dependence on a thickness 22 of the applied material 14 recorded by means of the sensor element 20. The actuator unit 32 may be configured to move the closing and/or stripping element 34 translationally or rotationally. The actuator unit 32 is preferably configured to move the closing and/or stripping element 34 translationally along a movement axis 68 (cf. FIG. 3) of the closing and/or stripping element 34 that runs at least substantially perpendicularly to the bearing surface 26. The closing and/or stripping element 34 is preferably movably mounted translationally in relation to a counter element, in particular a counter doctor blade (not represented any more specifically here) of the material application unit 12. The counter element, in particular the counter doctor blade, is arranged at the application opening 62, in particular on the material receiving element 64, such that it lies opposite the closing and/or stripping element 34, in particular considered along a direction running at least substantially parallel to the movement axis 68. The computing unit 66 is preferably configured to activate the actuator unit 32 in dependence on processing of sensor signals of the sensor element 20.

The recording unit 18 has at least one holding-down element 24 (cf. FIGS. 2 to 4), which is configured to subject the carrier element 16 at least section-wise to a force in the direction of the bearing surface 26 of the material application unit 12 on which the carrier element 16 at least partially rests. The holding-down element 24 is preferably arranged on the bearing surface 26 on a side of the carrier element 16 that is facing away from the sensor element 20.

The carrier element 16 can preferably be moved over the holding-down element 24 during operation of the production device 10, in particular along a direction running at least substantially parallel to the bearing surface 26, while the holding-down element 24 is subjecting the carrier element 16 to a force in the direction of the bearing surface 26. The holding-down element 24, in particular a holding-down surface 70 of the holding-down element 24, preferably has a maximum longitudinal extent which is a multiple less than a maximum longitudinal extent of the bearing surface 26. In a state of the holding-down element 24 in which it is arranged on the bearing surface 26, the maximum longitudinal extent of the holding-down element 24, in particular the holding-down surface 70 of the holding-down element 24, preferably runs at least substantially parallel to a transporting direction 72 (cf. FIGS. 2 and 3) of the production device 10, in particular in the region of the material application unit 12 along which the carrier element 16 is moved during operation of the production device 10.

The recording unit 18 has at least one holding-down element 24, the sensor element 20 and the holding-down element 24 being arranged overlapping (cf. FIGS. 2 to 4), in particular considered along a direction running at least substantially perpendicularly to the bearing surface 26 of the material application unit 12. The holding-down element 24 and the sensor element 20 are preferably arranged at a distance in relation to one another along the direction running at least substantially perpendicularly to the bearing surface 26 of the material application unit 12.

The recording unit 18 has at least the holding-down element 24, which is formed as a negative-pressure holding element, in particular as a vacuum gripper or as a flow gripper. The holding-down element 24 may be formed as a flat suction gripper, as a bellows suction gripper or as some other vacuum gripper that appears appropriate to a person skilled in the art. The recording unit 18 preferably comprises a connection interface 74 for a connection of the holding-down element 24 to an external negative-pressure device (not represented any more specifically) or the recording unit 18 itself comprises a negative-pressure generator 76 (cf. FIG. 3), which is connected to the holding-down element 24 by means of a negative-pressure line 78 of the recording unit 18, in particular by way of the connection interface 74. It is also conceivable that the holding-down element 24 generates the negative pressure itself, such as for example by the holding-down element 24, which is supplied with compressed air, controlling or regulating, such as for example by means of a valve arranged on the holding-down element 24, an intensity of the compressed air, in particular of the compressed air flowing out of the holding-down element 24, in particular in order to vary a magnitude of a holding-down force. The recording unit 18 has at least the holding-down element 24, which is arranged on the bearing surface 26 of the material application unit 12 within a recording region of the sensor element 20. The recording unit 18 has at least the holding-down element 24, which has a maximum holding-surface extent 28 (cf. FIG. 4) which is less than a maximum transverse extent 30 of the bearing surface 26 of the material application unit 12. The holding-down surface 70 of the holding-down element 24 is preferably arranged on the bearing surface 26 of the material application unit 12 within the recording region of the sensor element 20. A main emitting direction 80 (cf. FIG. 2) of the sensor element 20 preferably intersects the holding-down surface 70 of the holding-down element 24. The main emitting direction 80 of the sensor element 20 preferably runs transversely, in particular at least substantially perpendicularly, to the bearing surface 26 of the material application unit 12 (cf. FIGS. 2 to 4).

FIG. 5 shows a schematic sequence of a method 36 for a production of thermoset semifinished products, in particular by using the production device 10. Preferably, the material 14 to be applied is produced in at least one method step 82, in particular as a result of mixing of individual components of the material 14, such as for example a crosslinkable resin, additives, such as for example additives for reducing shrinkage, release agents, catalysts or the like. After production, in particular after mixing, the material 14 to be applied is preferably fed to the production device 10, in particular the material application unit 12, in at least one method step 84. In particular after mixing, the material 14 to be applied is preferably applied to the carrier element 16 by means of the material application unit 12 in at least one method step 86.

In at least one method step 38, the thickness 22, in particular maximum thickness, of the material 14, in particular the resin matrix, applied to the carrier element 16 is recorded by means of the sensor element 20, in particular the optical sensor element, of the recording unit 18. The thickness 22, in particular maximum thickness, of the material 14, in particular the resin matrix, applied to the carrier element 16 is preferably monitored in the method step 38, in particular as a result of an evaluation of the signal data of the sensor element 20 by the computing unit 66. In the method step 38, the carrier element 16 is at least section-wise subjected to a force in the direction of the bearing surface 26 of the material application unit 12 on which the carrier element 16 at least partially rests, by means of the holding-down element 24 of the recording unit 18.

In at least one method step 40, preferably fibers, in particular cut fibers, are applied to the carrier element 16, on which the material 14, in particular the resin matrix, has already been applied. In particular, in at least one method step 88, the material 14, in particular the resin matrix, is once again applied to the carrier element 16 on which the material, in particular the resin matrix, and the fibers have already been applied. Preferably, in at least one method step 90, feeding of the carrier element 16 and of the material 14 applied to it to the drying unit 56 of the production installation 42 takes place. Alternatively, it is also conceivable that the production installation is formed without the drying unit 56, feeding of the carrier element 16 and the material 14 applied to it to a storage unit (not represented any more specifically here) taking place in at least one method step, in order to carry out a maturing process. For example, for the maturing process, the carrier element 16 and the material 14 applied to it are brought into a temperature-controlled space of the storage unit, the carrier element 16 and the material 14 applied to it remaining there for a predetermined time, in particular a few days, to mature. During the maturing, preferably the viscosity of the resin matrix increases, so that during the following further processing the carrier element 16 can be pulled off from the material 14 and the material 14 can therefore also be handled without the carrier element 16. As already stated above, the maturing process can be realized within a short time period by means of the drying unit 56 of the production installation 42, in order to make advantageous direct further processing possible, in particular in a configuration of the method as a direct SMC production process. Drying, in particular by means of the drying unit 56 of the production installation 42, is preferably followed by further processing or storage of the carrier element 16 and the material 14 applied to it—in particular the thermoset semifinished product.

### DESIGNATIONS

10 Production device

12 Material application unit

14 Material

16 Carrier element

18 Recording unit

20 Sensor element

22 Thickness

24 Holding-down element

26 Bearing surface

28 Holding-surface extent

30 Transverse extent

32 Actuator unit

34 Closing and/or stripping element

36 Method

38 Method step

40 Method step

42 Production installation

44 Mixing unit

46 Fiber-cutting unit

48 Fiber-feeding unit

50 Material application unit

52 Production device

54 Carrier element

56 Drying unit

58 Conveying and/or transporting unit

60 Production device

62 Application opening

64 Material receiving element

66 Computing unit

68 Movement axis

70 Holding-down surface

72 Transporting direction

74 Connection interface

76 Negative-pressure generator

78 Negative-pressure line

80 Main emitting direction

82 Method step

84 Method step

86 Method step

88 Method step

90 Method step

1. A production device for a production of thermoset semifinished products, comprising at least one material application unit (12) for applying a material (14) to a carrier element (16), and at least one recording unit (18), which has at least one sensor element (20) for recording a thickness (22) of the material (14) applied to the carrier element (16).

2. The production device as claimed in claim 1, wherein the sensor element (20) is formed as a confocal-chromatic sensor.

3. The production device as claimed in claim 1, wherein the recording unit (18) has at least one holding-down element (24), which is configured to subject the carrier element (16) at least section-wise to a force in the direction of a bearing surface (26) of the material application unit (12), on which the carrier element (16) at least partially rests.

4. The production device as claimed in claim 1, wherein the recording unit (18) has at least one holding-down element (24), the sensor element (20) and the holding-down element (24) being arranged overlapping.

5. The production device as claimed in claim 1, wherein the recording unit (18) has at least one holding-down element (24), which is formed as a negative-pressure holding element.

6. The production device as claimed in claim 1, wherein the recording unit (18) has at least one holding-down element (24), which has a maximum holding-surface extent (28) which is less than a maximum transverse extent (30) of a bearing surface (26) of the material application unit (12).

7. The production device as claimed in claim 1, wherein the recording unit (18) has at least one holding-down element (24), which is arranged on a bearing surface (26) of the material application unit (12) within a recording region of the sensor element (20).

8. The production device as claimed in claim 1, further comprising at least one actuator unit (32), which is configured to set at least one position of a closing and/or stripping element (34) of the material application unit (12) in relation to a bearing surface (26) of the material application unit (12) and/or in relation to the carrier element (16) in dependence on a thickness (22) of the applied material (14) recorded by means of the sensor element (20).

9. A method for a production of thermoset semifinished products, wherein in at least one method step (38), a thickness (22) of a material (14) applied to a carrier element (16) is recorded by means of a sensor element (20) of a recording unit (18).

10. The method as claimed in claim 9, wherein in at least one method step (38), the carrier element (16) is at least section-wise subjected to a force in the direction of a bearing surface (26) of a material application unit (12) on which the carrier element (16) at least partially rests, by means of a holding-down element (24) of a recording unit (18).

11. The production device as claimed in claim 1, wherein the production device is embodied as an SMC production device.

12. The production device as claimed in claim 1, wherein the at least one material application unit (12) is embodied as a doctor blade unit.

13. The production device as claimed in claim 1, wherein the at least one sensor element (20) is an optical sensor element.

14. The production device as claimed in claim 1, wherein the recording unit (18) has at least one holding-down element (24), the sensor element (20) and the holding-down element (24) being arranged overlapping along a direction running at least substantially perpendicularly to a bearing surface (26) of the material application unit (12).

15. The production device as claimed in claim 5, wherein the at least one holding-down element (24) is embodied as a vacuum gripper.

16. The method as claimed in claim 9, wherein the method for producing thermoset semifinished products is performed by using the production device as claimed in claim 1.

17. The method as claimed in claim 9, wherein the material (14) is a resin matrix.
